(19) United States
(12) Patent Application Publication
(10) Pub. No.: US 2005/0091224 A1
(43) Pub. Date: Apr. 28, 2005

(54) Collaborative web based development interface

(76) Inventors: James A. Fisher, Tucson, AZ (US); Jeffrey W. Pilch, Tucson, AZ (US)

Correspondence Address: LAW OFFICE OF CHARLES W. PETERSON, JR. TUCSON, 11703 BOWMAN GREEN DR, suite 100, RESTON, VA, 20190, US

(21) Appl. No.: 10/690,883

(22) Filed: Oct. 22, 2003

(51) Int. Cl. G06F 7/00

(52) U.S. Cl. 707/100

(57) ABSTRACT

A data structure for repeated data items presented in tabular lists in a web based management interface, to a collaborative web based management interface design system and to a system and program product including the data structure. The data structure includes a page pointer table with links to repeatable data structures and corresponding page maps. The page maps have links to tabular lists in corresponding repeatable data structures. The page pointer table may be included in executable code modules generating variable data and generating web pages from the data. Adding web pages to the interface only increases the size of the executable code modules by the size of a repeatable data structure link, a map page link and a map page length indicator.

### CROSS REFERENCE TO RELATED APPLICATION

The present invention is related to a U.S. patent application Ser. No. 09/852,959 entitled “System and Method for Improving The Performance of a Web Application by Building Only Requested Web Pages Only in A Requested Human Language” to Brewer et al., filed May 10, 2001, published Nov. 14, 2002 as Published Application No. 2002/0169802 and assigned to the assignee of the present invention.

### BACKGROUND OF THE INVENTION

1. Field of the Invention

The present invention is related to web-based management interfaces and more particularly to a collaborative design system for designing web-based management interfaces.

2. Background Description

Increasingly, network based devices include a web-based management interface that provides users with information such as system status. Since the system status information may be changing, constantly, a typical such web interface application is designed to dynamically build and rebuild new web pages with every information change. The typical interface may provide web pages built from a collection of hypertext mark up language (HTML) files with placeholders in markup text for receiving and displaying dynamic input data. An executable code module can generate variable data, which another executable code module receives and combines with the HTML template files to produce complete HTML documents. The HTML documents are transferred to web-based clients using standard hypertext transport protocol (http) and displayed as web pages.

Typically, such an interface is a collaboratively designed by a number of groups with design responsibility for the HTML template files and executable code modules assigned to each of the groups. The development groups must maintain good communications during design. The executable code modules must designed to provide whatever variable data is necessary and in an acceptable format and, then, combine the data with the HTML template files in the correct placeholder locations to provide useful pages. Further, the web pages may include repeated item structures that are stored in system memory which must be locatable by the executable code modules. Frequent calls for those repeated structures can increase the size of the executable code, inefficiently using system resources and restricting HTML template file design, thereby impairing and/or impeding the coding effort. As a result, these design constraints may limit what tabular data can be incorporated into the final web pages or how many pages are available.

Thus, there is a need for an efficient collaborative design system for designing web-based management interfaces and for collecting variable data and passing collected data for display in web pages provided by the particular web-based management interface.

### SUMMARY OF THE INVENTION

It is a purpose of the invention to control executable code module size growth;

It is another purpose of the invention to improve the tabular data handling efficiency of web-based management interfaces;

It is yet another purpose of the invention to maintain good communications between design groups designing parts of a web-based management interfaces;

It is yet another purpose of the invention to increase HTML template file and web page design flexibility when incorporating tabular data into the web pages;

It is yet another purpose of the invention to optimize storage of repeated item structures and facilitate the location of such structures by executable code modules to improve system resource efficiency and to allow a more dynamic coding effort.

The present invention relates to a data structure for repeated data items presented in tabular lists in a web based management interface, to a collaborative web based management interface design system and to a system and program product including the data structure. The data structure includes a page pointer table with links to repeatable data structures and corresponding page maps. The page maps have links to tabular lists in corresponding repeatable data structures. The page pointer table may be included in executable code modules generating variable data and generating web pages from the data. Adding web pages to the interface only increases the size of the executable code modules by the size of a repeatable data structure link, a map page link and a map page length indicator.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a collaborative system for designing web-based management interfaces according to a preferred embodiment of the present invention;

FIG. 2 shows an example of how variable data was organized in a prior data structure;

FIG. 3 shows an example of data organized and maintained in accordance with the present invention.

### DESCRIPTION OF PREFERRED EMBODIMENTS

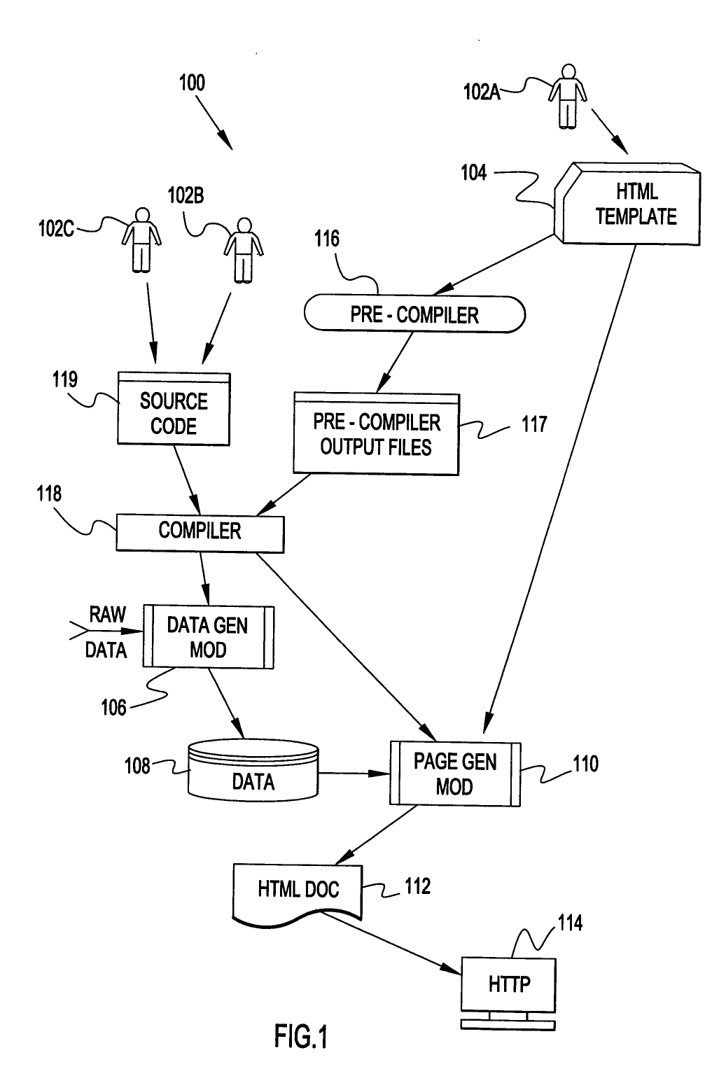

FIG. 1 shows an example of a collaborative system 100 for designing web-based management interfaces with design functions distributed amongst a number of design groups 102A, 102B, 102C according to a preferred embodiment of the present invention. The collaborative system has application to designing a web-based management interface for displaying system information on web pages such as for example, for the IBM Corporation's TotalStorage™ Enterprise Tape Library 3494. The collaborative system 100 includes a collection of hypertext mark up language (HTML) template files 104 with placeholders in markup text for reducing dynamic input data. An executable code module or data generation module 106 generates variable data, e.g., from system monitored parameters, which may be stored in input data store 108. Preferably, input data store 108 is non-volatile storage, although, any suitable volatile storage may be used as well. A second executable code module or page generation module 110 combines the variable data with appropriate HTML template files 104 to produce complete HTML documents 112, e.g., as described in U.S. patent application Ser. No. 09/852,959 entitled “System and Method for Improving The Performance of a Web Application by Building Only Requested Web Pages Only in A Requested Human Language” to Brewer et al., filed May 10, 2001, published Nov. 14, 2002 as Published Application No. 2002/0169802, assigned to the assignee of the present invention and incorporated herein by reference The HTML documents 112 are transferred to web-based clients 114 using standard hypertext transport protocol (http) and displayed as web pages. 17 The design groups 102A, 102B, 102C independently and simultaneously design and/or modify of each of the HTML template files 104 and the data and page generation modules 106, 110, respectively. Thus, for this example, a development team may have responsibility split with groups 102B and 102C responsible for developing the two executable code modules 106, 110 and group 102A generating the HTML template files 104. As design group 102A designs new or updates old HTML templates, the HTML template files are passed to a pre-compiler 116. The pre-compiler 116 converts the HTML template files 104 to source and header files 117, preferably, in C language, which are passed to a compiler 118. Similarly, design teams 102B and 102C provide source code files 119 to the compiler 118 with the two executable code modules 106, 110, also, preferably, C language files. The compiler 118 combines the pre-compiler output files 117 with the source code files 117 to generate the data generation module 106 and the page generation module 110.

Thereafter during operation, the data generation module 106 receives and formats raw system data and stores it, locally in data store 108. Once a request is placed for the data, e.g., selecting the web address for the particular HTML document, the page generation module 110 selects the appropriate HTML template 104 and retrieves the corresponding data from the local data store 108. Then, the page generation module 110 combines the data in data store 108 with the HTML templates 104 to create HTML documents 112 for display 114.

The development groups 102A, 102B and 102C must necessarily maintain good communications. The data generation module 106 must provide whatever variable data is necessary and in the proper format. The page generation module 110 must accept the variable data and combine it with the HTML template files 104 in the correct placeholder locations to generate useful pages. The pre-compiler 116 facilitates this communication, operating on the HTML template files 104 to extract the placeholder names and produce a C language source code file and a header file that may then be used in compiling the data and page generation modules 106, 110. Once design is complete, the compiler 118 and pre-compiler are no longer necessary and the final web-based management interface includes the data generation module 106 generating variable data and stored in input data store 108 and which the page generation module 110 combines appropriate HTML template files 104 to produce complete HTML documents 112 for display 114.

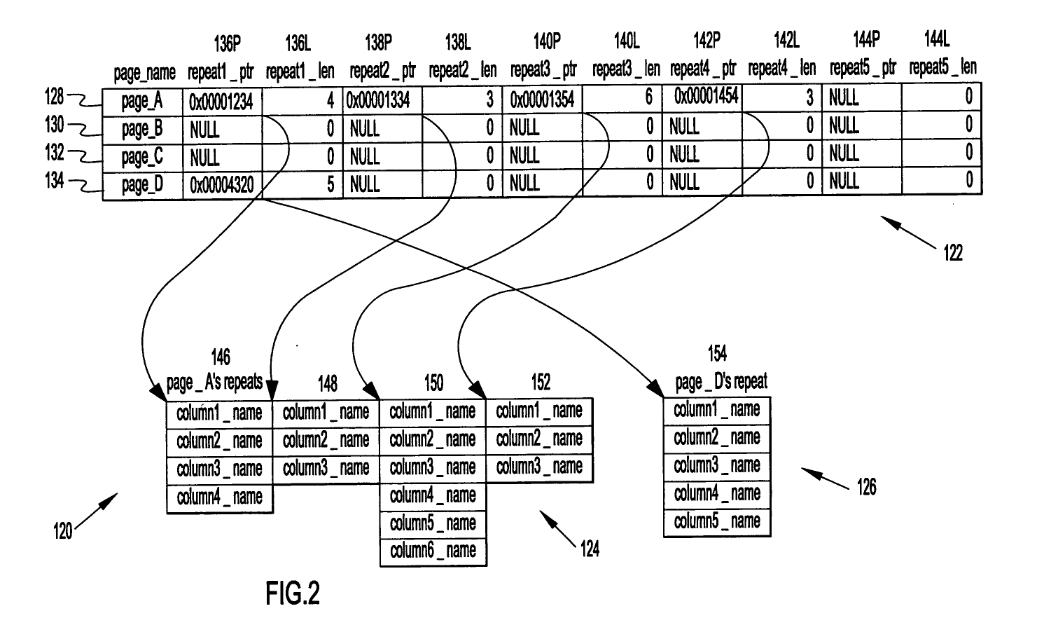

FIG. 2 shows a prior data structure example 120 of how variable data was organized, e.g., which the executable modules combined with HTML files building system web pages for display such as described in Brewer et al. In this data structure example 120 variable data was organized within the executable code modules, e.g., 106, 110 in FIG. 1, and stored as the dynamic input data for subsequent display as tabular data used in developing a typical state of the art web-based management interface. A page pointer table 122 in each executable code module 106, 110 includes links to repeated item structures 124, 126 in the pre-compiler output 117, e.g., in C language source and header files that the pre-compiler 116 may generate. The page pointer table 122 includes a page entry 128, 130, 132, 134 for each web page. Each page entry 128, 130, 132, 134 includes a pair of entries 136P, 136L, 138P, 138L, 140P, 140L, 142P, 142L, 144P, 144L for each of a number (N, N=5 in this example) of defined tabular data lists, regardless of whether one, N or no lists are included in a particular web page. For each pair of list entries 136P, 136L, 138P, 138L, 140P, 140L, 142P, 142L, 144P, 144L, one entry (e.g., 140P) is a 32 bit pointer to a corresponding tabular data list 146, 148, 150, 152, 154 for the particular page. The second 16 bit entry (e.g., 140L) indicates the number of columns 156 in the particular tabular data list 146, 148, 150, 152, 154. Each page 128, 130, 132, 134 includes a list entry pair 136P, 136L, 138P, 138L, 140P, 140L, 142P, 142L, 144P, 144L, regardless of whether the particular web page includes a corresponding list or not, e.g., null/zero entry pair 144P, 144L.

So, in this example, each tabular data list 146, 148, 150, 152, 154 has similar information organized into number of columns determined by the corresponding second entry 136L, 138L, 140L, 142L, 144L and a variable number of rows. The corresponding HTML template files 104 for this facility has placeholders embedded for each of the columns inside a pairing of start and end markers. For this simple example (i.e., N=5), the pre-allocated memory requirements places a significant constraint on the executable code. Each pair of entries 136P, 136L, 138P, 138L, 140P, 140L, 142P, 142L, 144P, 144L in this example requires six bytes in the code or 30 bytes for each page, even though many of the pages do not include tabular data lists. Since, typically, such an interface may exceed 200 pages, corresponding NULL/zero entry pair values are included, bloating data and page generation module 106, 110 by 6 Kbytes. Further, expanding the number lists (e.g., N=18) exacerbates this problem. For 213 pages, for example, increasing from 5 tabular data lists at 30 bytes per page to 18 at 108 further bloats the data and page generation module 106, 110 sizes from 6,390 bytes to 23,004 bytes.

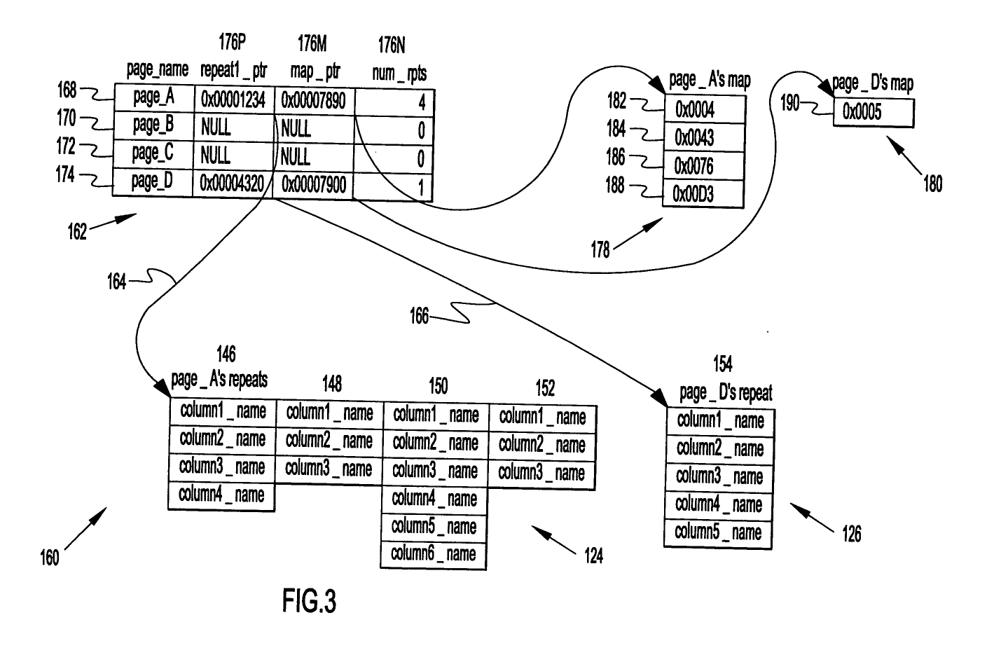

FIG. 3 shows a preferred data structure example 160 of variable data for tabular data lists 146, 148, 150, 152, 154, as organized within the executable code modules 106, 110 of FIG. 1 and stored as the dynamic input data 108, in accordance with the present invention. By contrast, the page pointer table 162 has a single link 164, 166 to each repeated item list 124, 126 in dynamic input data store 104. Thus, each page entry 168, 170, 172, 174 has a single entry triplet 176P, 176M, 176N with the single page link 164, 166 indicated by entry triplet pointer 176P, again a 32 bit pointer. However, instead of individual links to each tabular data list 146, 148, 150, 152, 154, the page pointer table 162 includes a corresponding 32 bit pointer 176M to a page map 178, 180 with an 8 bit (for N≦255) number 176N indicating the number of page map entries. Each page map 178, 180, which are also in the pre-compiler output 117 with item structures 124, 126, includes an index 182, 184, 186, 188, 190 for each tabular data list 146, 148, 150, 152, 154. In this example, each map index entry is 16-bits, with twelve bits representing an offset into the data relative to entry triplet pointer 176P for the corresponding single page link 164, 166 and, the remaining four bits indicating the number of columns in the respective tabular data list 146, 148, 150, 152, 154 for the individual repeated item. So, as can be seen from the example of FIG. 3, the offset is zero for the first tabular data or repeated item list, 182, 190 on each page and the length is indicated by the non-zero digit. For the second and subsequent repeated item lists 184, 186, 188 on a page, the offsets are cumulative so that, the offset for the entry is added to the sum of the previous offsets and the number of columns for each.

Thus, instead of storing a pointer to the beginning of a tabular list for each repeated item structure and an integer to describe the structure's width, each page is described by an individual map 178, 180, which is a single data structure holding all of the information (offset pointers and column numbers) necessary to describe all of the repeated item structures on a given web page. Further, by storing the page maps 178, 180, e.g., with dynamic data in store 104, the page pointer table 162, which points to each map 178, 180, provides a much more efficient master data structure, requiring 36 bytes in the executable modules to describe the same structure described in FIG. 2. Each additional page only increases executable module size by just nine (9) bytes to describe an essentially arbitrary number of repeated item lists on that additional page. Advantageously, for the above example of 213 pages (regardless of whether there are 5 or 18 possible tabular data lists) the code expands only by 1917 bytes instead of 6K to 23K. Further, for any page not including repeated item structures or lists, as is typical of most of the pages, there will only be nine wasted bytes for a null/null/zero triplet, instead of N*6, i.e., 30 for the example of FIG. 2.

The pre-compiler conveniently and seamlessly adapts the same unmodified source code used for the executable modules from the data structure 120 of FIG. 2 to a preferred structure as in the example 160 of FIG. 3. The tabular data lists can be extracted and generated quickly and easily, shifting as indicated by the 4 bit length value and masking with the twelve offset bits to locate the page tables. Thus, advantageously, repeated item structures are stored in system memory and addressed in the executable code for more efficient system resource use and for a more dynamic coding effort. Designers face fewer restrictions and so, have significantly more freedom in designing HTML template and in particular in incorporating tabular data into the web pages.

Advantageously, because variable system data is structured to minimize the impact of adding tables and pages with tables on code used in generating the pages, teams can now work together of a project much more easily than was heretofore possible. Source code developers, teams 102B and 102C, no longer need make difficult and risky changes to the operation of their code just support page layout decisions made by team 102A. Page layout team 102A no longer needs to avoid making page layout changes because such changes are no longer met with resistance to such changes from code developer teams 102B and 102C. As a result, the teams 102A, 102B, 102C can dedicate most of their time working freely on that aspect of the system in which each is a specialist, creating a final system that is of higher quality than would have otherwise been produced.

While the invention has been described in terms of preferred embodiments, those skilled in the art will recognize that the invention can be practiced with modification within the spirit and scope of the appended claims.

1. A computer-readable medium having stored thereon a data structure for data presented in tabular lists in a web based management interface, said data structure comprising:
a page pointer table including link entries for each of a plurality of web pages selectable for display;
one or more repeatable data structures, each of said repeatable data structures being linked to one of said plurality of web pages; and
one or more page maps, each of said repeatable data structures having a corresponding page map, each said corresponding page map pointing to one or more corresponding tabular lists in a corresponding repeatable data structure.

2. A computer-readable medium as in claim 1, wherein said page pointer table includes at least one null entry for a web page that does not include any said repeatable data structure.

3. A computer-readable medium as in claim 1, wherein said page pointer table includes a link to each of said one or more page maps.

4. A computer-readable medium as in claim 3, wherein said page pointer table indicates the length of each of said one or more page maps.

5. A computer-readable medium as in claim 4, wherein at least one said corresponding page map includes a plurality of entries, each of said plurality of entries pointing to a corresponding one of said corresponding tabular lists.

6. A computer-readable medium as in claim 5, wherein each entry in said plurality of entries includes an offset from a first listed data element and a plurality of listed data elements in said corresponding one.

7. A computer-readable medium as in claim 5, wherein said page pointer table is included in executable modules generating selected web pages for display from said plurality of web pages and adding web pages to said plurality of web pages increases the size of each of said executable modules only by the length of the corresponding said page pointer entry for each said added page.

8. A collaborative design system for designing web-based management interfaces with design functions distributed amongst a number of design groups, each said web-based management interface providing selection amongst a plurality of web pages selectable for display, said system comprising:
a data generation module generating variable data for display;
a collection of hypertext mark up language (HTML) template files, ones of said HTML template files including placeholders in markup text for dynamic input data;
a page generation module selectively providing HTML documents from said HTML template files, said page generation module combining said variable data with said placeholders in selected said ones; and
each of said data generation module and said page generation module including a page pointer table with a single entry for each of said HTML template files, each said single entry for each of said ones pointing to a corresponding repeatable data structure and a page map for tabular data lists in said corresponding repeatable data structure, said tabular data lists being displayed as a table on a generated said HTML document.

9. A collaborative design system as in claim 8, wherein adding HTML template files increases the size of each of said data generation module and said page generation module only by the length of a corresponding said single entry for each said added HTML template file.

10. A collaborative design system as in claim 8, wherein each said single entry further includes a number indicating the length of said page map.

11. A collaborative design system as in claim 8, wherein at least one said page map includes a plurality of entries, each of said plurality of entries pointing to a corresponding one of said tabular data lists.

12. A collaborative design system as in claim 11, wherein each entry in said plurality of entries includes an offset from a first listed data element and a number of listed data elements in said corresponding one.

13. A collaborative design system as in claim 8, wherein design responsibility for each of said data generation module, said page generation module and said HTML template files is assignable to a different design group.

14. A system having a web-based management interface providing selection amongst a plurality of web pages selectable for display, said web-based management interface comprising:
a data generation module generating variable data for display;
a hypertext mark up language (HTML) template file collection, ones of said HTML template files including placeholders in markup text for dynamic input data;
a page generation module selectively providing HTML documents from said HTML template files, said page generation module combining said variable data with said placeholders in selected said ones; and
each of said data generation module and said page generation module including a page pointer table with a single entry for each of said HTML template files, each said single entry for each of said ones pointing to a corresponding repeatable data structure and a page map for tabular data lists in said corresponding repeatable data structure, said tabular data lists being displayed as a table on a generated said HTML document.

15. A system as in claim 14, wherein each said single entry further includes a number indicating the length of said page map.

16. A system as in claim 15, wherein at least one said page map includes a plurality of entries, each of said plurality of entries pointing to a corresponding one of said tabular data lists and each of said plurality of entries includes an offset from a first listed data element and a number of listed data elements in said corresponding one.

17. A program product for managing a system, said computer program product comprising a computer usable medium having computer readable program code thereon, said computer readable program code comprising:
computer readable program code means for generating variable data for display and storing generated said variable data according to a page pointer table, said page pointer table having a single entry for each of a plurality of hypertext mark up language (HTML) files, each said single entry pointing to a corresponding repeatable data structure and a page map for tabular data lists in said corresponding repeatable data structure, said tabular data lists listing said generated data;
computer readable program code means for defining said plurality of HTML files; and
computer readable program code means for selectively generating HTML documents from defined said HTML files and stored said variable data.

18. A program product as in claim 17, wherein each said single entry further indicates the length of said page map.

19. A program product as in claim 18, wherein each entry in each said page map includes an offset pointing to a corresponding one of said tabular data lists and a number of listed data elements in said corresponding one.
